(19) United States
(12) Patent Application Publication
(10) Pub. No.: US 2017/0213252 A1
(43) Pub. Date: Jul. 27, 2017

(54) REDUCING DATA NOISE USING FREQUENCY ANALYSIS

(71) Applicant: Google Inc., Mountain View, CA (US)

(72) Inventors: Terrence Rohan, Atherton, CA (US); Tomasz J. Tunguz-Zawislak, San Francisco, CA (US); Jeremiah Harmsen, San Jose, CA (US); Sverre Sundsdal, Brooklyn, NY (US); Thomas M. Annau, San Carlos, CA (US); Megan Nance, Sunnyvale, CA (US); Mayur Dhondu Datar, Santa Clara, CA (US); Julie Tung, Mountain View, CA (US); Bahman Rabii, San Francisco, CA (US); Jason C. Miller, Mountain View, CA (US); Michael Hochberg, Los Altos, CA (US); Andres S. Perez-Bergquist, Mountain View, CA (US)

(21) Appl. No.: 15/431,000

(22) Filed: Feb. 13, 2017

Related U.S. Application Data
(63) Continuation of application No. 11/694,345, filed on Mar. 30, 2007, now abandoned.

(51) Int. Cl. G06Q 30/02; G06Q 50/00

(52) U.S. Cl. CPC G06Q 30/0269; G06Q 50/01; G06Q 30/0277

(57) ABSTRACT

The subject matter of this document generally relates to reducing noise in aggregated data using frequency analysis. In some implementations, a system for reducing data noise using frequency analysis includes a data storage device that stores content and a network association processor in data communication with the data storage device. The network association processor aggregates, for a given group, content of one or more additional groups that each have overlapping members with the given group. The network association processor reduces noise in the aggregated content of the one or more additional groups using frequency analysis by determining, for each portion of content in the aggregated content, a frequency of occurrence of the portion of content within the aggregated content and filtering, from the aggregated content, each portion of content that has a frequency of occurrence that is less than a threshold.

### BACKGROUND

Online social networks have become popular for professional and/or social networking. Some online social networks provide content items that may be of interest to users, e.g., digital advertisements targeted to a user, or identification of other users and/or groups that may be of interest to a user. The content items can, for example, be selected based on content of a user account, e.g., based on keywords identified from a crawl of a user's page. Such content item identification schemes, however, may not identify optimum content items if the user has provided incomplete or incorrect content data, e.g., misspelled words, random quotes, incomplete profiles, etc. Accordingly, some of the content items, e.g., advertisements directed to particular products, may not be of interest to many users of an online social network.

### SUMMARY

Described herein are systems and methods for facilitating content identification based on related entities. In one implementation, and entity relationship defining an entity, e.g., a friendship relation in a social network, user groups, etc., can be identified and entity content based on the entity relationship, e.g., user profile data of user accounts, group memberships, etc., can be processed to identify entity topics. One or more content items, e.g., advertisements, can be identified based on the entity topics.

In another implementation, a first entity in a social network, e.g., a user or a group, can be identified, and second entities related to the first entity can also be identified. The first entity and the second entities can define entity content, and one or more entity topics can be identified based on the entity content. The entity topics can be utilized to facilitate identification of one or more content items.

In another implementation, a data processing subsystem can be configured to identify related entities in a social network and to identify topics based on the content defined by the related entities. A content item server can be configured to identify content items relevant to the identified topics and to manage the identified content items based on a relevance to the identified topics.

### BRIEF DESCRIPTION OF THE DRAWINGS

FIG. 1 is a block diagram of an example system for identifying content items based on an entity defined by a relationship in a social network.

FIG. 2 is a more detailed block diagram of the example system for identifying content items and topics based on entity relationships in a social network.

FIG. 3 is a flow diagram of an example process for identifying content items based on an entity relationship.

FIG. 4 is a flow diagram of an example process for identifying entity content based on an entity relationship.

FIG. 5 is a flow diagram of an example process for identifying an entity relationship defining an entity.

FIG. 6 is a flow diagram of another example process for identifying an entity relationship defining an entity.

FIG. 7 is a flow diagram of an example process for identifying entity topics.

FIG. 8 is a flow diagram of an example process for identifying content items based on a relationship defined by entities in a social network.

FIG. 9 is a block diagram of an example computer system that can be utilized to implement the systems and methods described herein.

### DETAILED DESCRIPTION

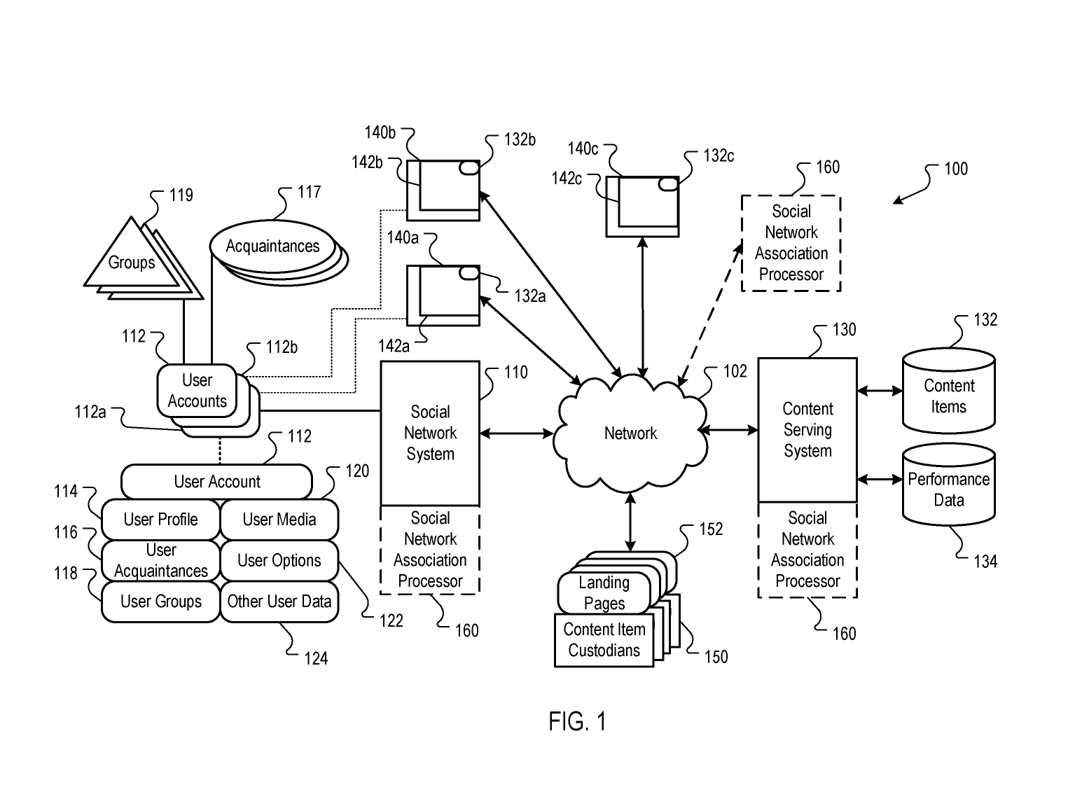

FIG. 1 is a block diagram of an example system 100 for identifying content items based on entities defined by relationships in a social network system 110. An entity relationship defining an entity, e.g., a friendship relation in a social network defining an entity of multiple users, user groups, etc., can be identified and entity content based on the entity relationship, e.g., user profile data of user accounts, group memberships, etc., can be processed to identify entity topics. The entity topics can, for example, be processed by aggregating and/or smoothing the entity content to form a composite entity content representation, e.g., entity topics. One or more content items, e.g., advertisements, can be identified based on the composite entity content representation.

In an implementation, the social network system 110 can, for example, host numerous user accounts 112. An example social network system can include Orkut, hosted by Google Inc., of Mountain View, Calif. Other social networks can, for example, include school alumni websites, an internal company web site, dating networks, etc.

Each user account 112 can, for example, include user profile data 114, user acquaintance data 116, user group data 118, user media data 120, user options data 122, and other user data 124.

The user profile data 114 can, for example, include general demographic data about an associated user, such as age, sex, location, interests, etc. In some implementations, the user profile data 114 can also include professional information, e.g., occupation, educational background, etc., and other data, such as contact information. In some implementations, the user profile data 114 can include open profile data, e.g., free-form text that is typed into text fields for various subjects, e.g., “Job Description,” “Favorite Foods,” etc., and constrained profile data, e.g., binary profile data selected by check boxes, radio buttons, etc., or predefined selectable profile data, e.g., income ranges, zip codes, etc. In some implementations, some or all of the user profile data 114 can be classified as public or private profile data, e.g., data that can be shared publicly or data that can be selectively shared. Profile data 114 not classified as private data can, for example, be classified as public data, e.g., data that can be viewed by any user accessing the social network system 110.

The user acquaintances data 116 can, for example, define user acquaintances 117 associated with a user account 112. In an implementation, user acquaintances 117 can include, for example, users associated with other user accounts 112 that are classified as “friends,” e.g., user accounts 112 referenced in a “friends” or “buddies” list. Other acquaintances 117 can also be defined, e.g., professional acquaintances, client acquaintances, family acquaintances, etc. In an implementation, the user acquaintance data 116 for each user account 112 can, for example, be specified by users associated with each user account 112, and thus can be unique for each user account 112.

The user group data 118 can, for example, define user groups 119 to which a user account 112 is associated. In an implementation, user groups 119 can, for example, define an interest or topic, e.g., “Wine,” “Open Source Chess Programming,” “Travel Hints and Tips,” etc. In an implementation, the user groups 119 can, for example, be categorized, e.g., a first set of user groups 119 can belong to an “Activities” category, a second set of user groups 119 can belong to an “Alumni & Schools” category, etc.

The user media data 120 can, for example, include user documents, such as web pages. A document can, for example, comprise a file, a combination of files, one or more files with embedded links to other files, etc. The files can be of any type, such as text, audio, image, video, hyper-text mark-up language documents, etc. In the context of the Internet, a common document is a Web page.

The user options data 122 can, for example, include data specifying user options, such as e-mail settings, acquaintance notification settings, chat settings, password and security settings, etc. Other option data can also be included in the user options data 122.

The other user data 124 can, for example, include other data associated with a user account 112, e.g., links to other social networks, links to other user accounts 112, online statistics, account payment information for subscription-based social networks, etc. Other data can also be included in the other user data 124.

In an implementation, a content serving system 130 can directly, or indirectly, enter, maintain, and track content items 132. The content items 132 can, for example, include a web page or other content document, or text, graphics, video, audio, mixed media, etc. In one implementation, the content items 132 are advertisements. The advertisements 132 can, for example, be in the form of graphical ads, such as banner ads, text only ads, image ads, audio ads, video ads, ads combining one of more of any of such components, etc. The advertisements 132 can also include embedded information, such as links, meta-information, and/or machine executable instructions.

In an implementation, user devices 140a, 140b and 140c can communicate with the social network 110 over a network 102, such as the Internet. The user devices 140 can be any device capable of receiving the user media data 120, such as personal computers, mobile devices, cell phones, personal digital assistants (PDAs), television systems, etc. The user devices 140 can be associated with user accounts 112, e.g., the users of user devices 140a and 140b can be logged-in members of the social network system 110, having corresponding user accounts 112a and 112b. Additionally, the user devices 140 may not be associated with a user account 112, e.g., the user of the user device 142c may not be a member of the social network system 110 or may be a member of the social network system 110 that has not logged in.

In one implementation, upon a user device 140 communicating a request for media data 120 of a user account 112 to the social network 110, the social network 110 can, for example, provide the user media data 120 to user device 140. In one implementation, the user media data 120 can include an embedded request code, such as Javascript code snippets. In another implementation, the social network system 110 can insert the embedded request code with the user media data 120 when the user media data 120 is served to a user device 140.

The user device 140 can render the user media data 120 in a presentation environment 142, e.g., in a web browser application. Upon rendering the user media data 120, the user device 140 executes the request code, which causes the user device 140 to issue a content request, e.g., an advertisement request, to the content serving system 130. In response, the content serving system 130 can provide one or more content items 132 to the user device 140. For example, the content items 132a, 132b and 132c can be provided to the user devices 140a, 140b and 140c, respectively. In one implementation, the content items 132a, 132b and 132c are presented in the presentation environments 142a, 142b and 142c, respectively.

In an implementation, the content items 132a, 132b and 132c can be provided to the content serving system 130 by content item custodians 150, e.g., advertisers. The advertisers 150 can, for example, include web sites having “landing pages” 152 that a user is directed to when the user clicks an advertisement 132 presented on a page provided from the social networking system 110. For example, the content item custodians 150 can provide content items 132 in the form of “creatives,” which are advertisements that may include text, graphics and/or audio associated with the advertised service or product, and a link to a web site.

In one implementation, the content serving system 130 can monitor and/or evaluate performance data 134 related to the content items 132. For example, the performance of each advertisement 132 can be evaluated based on a performance metric, such as a click-through rate, a conversion rate, or some other performance metric. A click-through can occur, for example, when a user of a user device, e.g., user device 140a, selects or “clicks” on an advertisement, e.g. the advertisement 132a. The click-through rate can be a performance metric that is obtained by dividing the number of users that clicked on the advertisement or a link associated with the advertisement by the number of times the advertisement was delivered. For example, if advertisement is delivered 100 times, and three persons clicked on the advertisement, then the click-through rate for that advertisement is 3%.

A “conversion” occurs when a user, for example, consummates a transaction related to a previously served advertisement. What constitutes a conversion may vary from case to case and can be determined in a variety of ways. For example, a conversion may occur when a user of the user device 140a clicks on an advertisement 132a, is referred to the advertiser's Web page, such as one of the landing pages 152, and consummates a purchase before leaving that Web page. Other conversion types can also be used. A conversion rate can, for example, be defined as the ratio of the number of conversions to the number of impressions of the advertisement (i.e., the number of times an advertisement is rendered) or the ratio of the number of conversions to the number of selections. Other types of conversion rates can also be used.

Other performance metrics can also be used. The performance metrics can, for example, be revenue related or non-revenue related. In another implementation, the performance metrics can be parsed according to time, e.g., the performance of a particular content item 132 may be determined to be very high on weekends, moderate on weekday evenings, but very low on weekday mornings and afternoons, for example.

It is desirable that each of the content items 132 be related to the interests of the users utilizing the user devices 140a, 140b and 140c, as users are generally more likely to select, e.g., click through, content items 132 that are of particular interest to the users. One process to identify relevant content items 132 includes processing content, e.g., text data and/or metadata, included in a page currently rendered in a viewing instance 142 on a user device 140, e.g. a web page related to a user account 112 rendered on the user device 140a. The viewing of a web page associated with a user account 112 can be interpreted as a signal that the user viewing the web page is interested in subject matter related to the content of the web page. Such a process can generally provide relevant content items 132; however, if the content of the web page is incomplete, or of low quality or quantity, then the content items 132 that are identified and served may not be relevant to the viewer's interests.

In an implementation, a signal of interest can be identified based on an entity relationship. An entity relationship can, for example, be defined by common user profile data 114 in user accounts 112, or by common acquaintances 117, or by one or more groups and related groups 119, or by other data that identifies an entity or entities in a broad sense. In an implementation, a social network association processor 160 can be utilized to facilitate identification of content items 132 based on entity relationships in the social network 110.

In one implementation, the social network association processor 160 can, for example, identify an entity relationship based on whether a user of a user device 140 is associated with a user account 112. For example, the users of user devices 140a and 140b can be logged-in members of the social network 110, having corresponding user accounts 112a and 112b. Accordingly, the social network association processor 160 can, for example, identify relationships defining an entity or entities that include the user account 112 associated with the logged-in users.

Likewise, the user of user device 140c can, for example, not be a member of the social network 110, or may be a member of the social network 110 but not logged into the social network 110. Accordingly, the social network association processor 160 can, for example, identify relationships defining an entity or entities that include entities that are viewed by the user device 140c, e.g., a particular group 119, a particular user account 112, etc.

Based on the identified entity relationships, the social network association processor 160 can identifying entity content, e.g., text data, user profile data, navigation history, etc. The entity content can, for example, be processed to identify entity topics, e.g., the entity content for a particular entity relationship may identify the topics of baseball sports and baseball pitchers as topics of interest defined by the entity content. The social network association processor 160 can, for example, provide the identified topics to the content serving system 130, which, in turn, can identify relevant content items 132, e.g., advertisements, based on the identified topics.

In one implementation, the social network association processor 160 can be integrated into the social network system 110. In another implementation, the social network association processor 160 can be integrated into the content server system 130. In another implementation, the social network association processor 160 can be a separate system in data communication with the social network system 110 and/or the content server system 130.

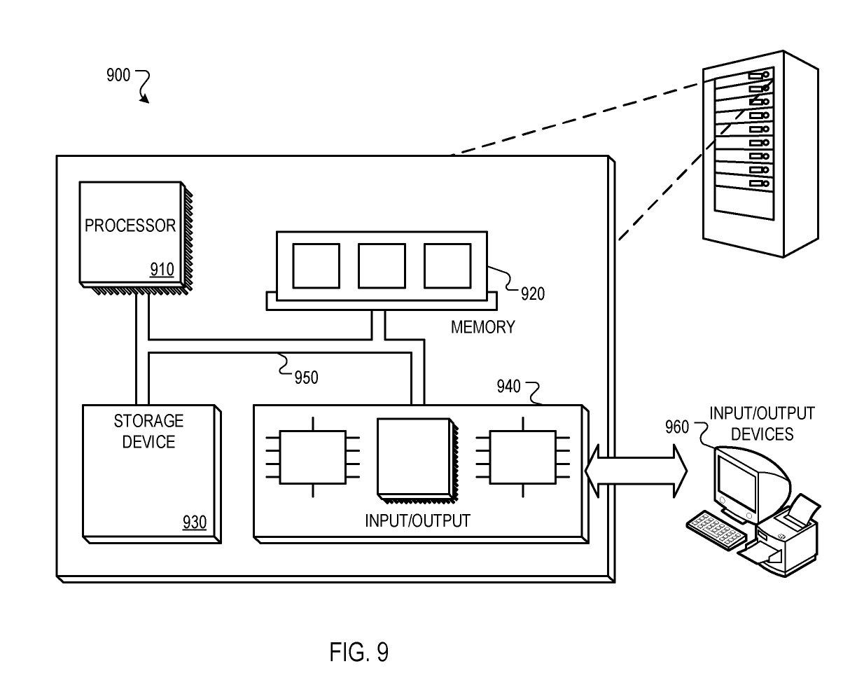

The social network association processor 160 can be implemented in software and executed on a processing device, such as the computer system 900 of FIG. 9. Example software implementations include C, C++, Java, or any other high-level programming language that may be utilized to produce source code that can be compiled into executable instructions. Other software implementations can also be used, such as applets, or interpreted implementations, such as scripts, etc.

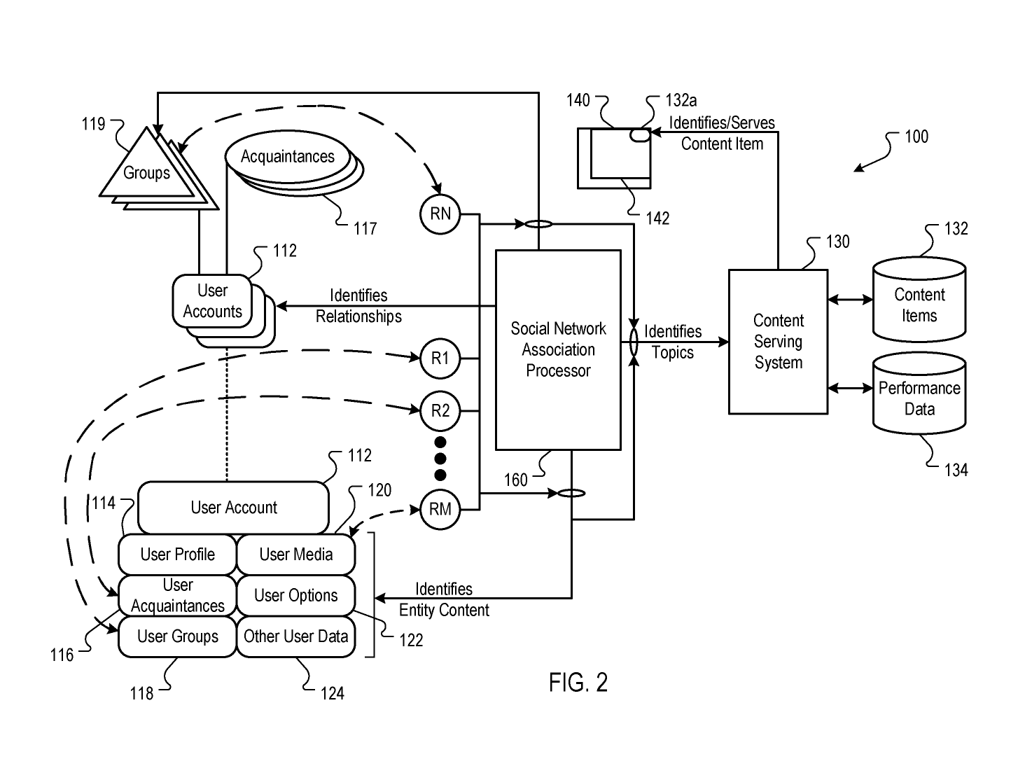

FIG. 2 is a more detailed block diagram of the example system 100 for identifying content items 132 based on entity relationships in a social network 110. In one implementation, the social network association processor 160 can identify an entity relationship defining an entity. The entity can, for example, include user accounts 112, and/or acquaintances 117, and/or groups 119. The entity relationship, e.g., R1, R2, . . . RM, RN, can, for example, be based on similar interests defined by the user accounts 112, and/or similar interests defined by the user accounts 112 of acquaintances of a particular user 112, and/or memberships of groups 119, or other identifiable signals.

In one implementation, entity relationships can, for example, include implicit entity relationships. The implicit entity relationships are, for example, entity relationships that are not defined explicitly within a user account or within other entities, such as groups; instead, the entity relationship is based on common behavior, and/or similar memberships in groups, and/or similar profile data, and/or other measures of similarity. In one implementation, the entity relationships can be identified by collaborative filter techniques. For example, entity relationships can be defined on a group 119 basis. Membership of a base group 119, e.g., a group 119 currently viewed or accessed by a user that is either associated with a user account 112 or is not a member or the social network, can be compared to memberships of other groups 119 to identify one or more other groups 119 that may be related to the base group 119 based on the memberships. For example, a base group 119 defining a first membership may be strongly related to a second group 119 defining a second membership that substantially overlaps with the first membership, and may be unrelated to a third group 119 that defines a third membership that has no overlap with the first membership.

In another implementation, entity relationships can, for example, include explicit entity relationships. The explicit entity relationships are, for example, entity relationships that are defined explicitly within a user account, a group membership, or some other entity. In one implementation, entity relationships can, for example, be identified by acquaintances 117. For example, a base user account 112 can be identified. A base user account 112 can, for example, be a user account 112 currently logged into, such as a user account 112a associated with the user device 140a; or a user account 112 accessed by a user that is either associated with another user account 112 or a associated with a user that is not a member or the social network, e.g., a user of the user device 140c, shown in FIG. 1. In one implementation, the user acquaintance data 116 of the base user account 112 can be accessed to identify acquaintances 119 of the base user account 112. In another implementation, the user acquaintance data 116 of the user accounts 112 defined by the acquaintance data 116 of the base user account 112 can also be accessed to identify additional acquaintances 119. Likewise, entity relationships can also be identified based on other data, such as the membership of a single group 119, a list of online “buddies,” etc.

In an implementation, entity relationships can, for example, be identified for each user account 112. For example, for a particular user account 112, the entity relationship R1, R2 . . . RM can be identified based on data related to the user account 112. The entity relationship R1, for example, can be based on the groups 119 to which the user account 112 is associated, as defined by the user group data 118. Likewise, the entity relationship R2, for example, can be based on the acquaintances 117 to which the user account 112 is associated, as defined by the user acquaintance data 116. Other entity relationships can also be identified based on data related to the user account 112, e.g., the entity relationship RN can, for example, be based on the user media data 120 of the user account 112 and other user accounts.

In an implementation, entity relationships can, for example, be identified for other entities in the social network 110, e.g., for groups 119. For example, for a particular group 119, the entity relations RM can be identified as described above. Accordingly, during a viewing instance of the particular group 119, e.g., when the group 119 is accessed as a base group by a user device 140 that may or may not be associated with a user account 112, the entity relationship related to the base group can be identified.

The social network association processor 160 can identify entity content based on the identified entity relationships R1, R2 . . . RM, RN. In one implementation, the entity content can be based on data related to the user accounts 112. For example, for the entity relationships R1, R2 . . . RM, the entity content can include corresponding user account data 118, 116 and 120 for each user account 112 associated with the identified entity relationships.

In another implementation, the entity content can be based on data related to non-user account entities, e.g., a group 119. For example, the entity content for the entity defined by the entity relationship RN can include text data, e.g., user posts, to the groups 119 associated with the entity relationship RN.

In another implementation, the entity content can include entity content based on data from the user accounts 112 and based on data from non-user account entities.

Because much of the identified entity content is user-created, the identified entity content may include incomplete or incorrect content data, e.g., misspelled words, random quotes, incomplete profiles, etc. For example, users may post inappropriate or irrelevant content to user groups 119, e.g., a user may post a political message to apolitical user group, e.g., a Wine group; or a user may not provide complete user profile data 114, or may provide incorrect user profile data, e.g., entering an age of 131. Such incomplete or incorrect data can constitute noise within the identified entity content, e.g., statistically insignificant or having an associated frequency occurrence below a threshold.

In one implementation, the social network association processor 160 can smooth the identified entity content to eliminate or mitigate the noise in the entity content. For example, the social network association processor 160 can aggregate the entity content and identifies common aggregated content, and entity topics related to the common aggregated content can be identified. Thus, if the aggregated user profile data 114 of an entity defines a demographic age range of 30-45 years, the incorrect age of 131 in a particular user account can be discounted. Likewise, an entity may include a base user group 119 related to the topic “Wine” and other user groups 119 related to the topics “Chardonnay” and “Napa Valley.” The “Chardonnay” user group, however, may include an off-topic thread related to politics. However, aggregation of the entity content may only identify the entity topics of “California” and “White Wine,” as the off-topic thread, when measured against the aggregate entity content, can be identified as noise.

In another implementation, the social network association processor 160 can identify entity topics based on keyword and/or phrase identification. The identified keywords and phrases can, for example, represent relative topics defined by the entity content. In one implementation, the keywords can be generated by identifying the most frequently occurring words within the entity content, excluding very common words such as “and,” “the,” “if,” etc. In another implementation, the keywords can be generated by automatically tagging the words according to grammar rules, such as noun, verb, adjective, etc., and identifying the most frequently occurring noun phrases as keywords or key phrases. Other keyword identification schemes can also be used, e.g., selecting words that are defined by a predetermined set of indexing words, etc.

Based on the identified entity topics, the content serving system 130 can identify one or more relevant content items 132. In one implementation, the content items can include advertisements, and are identified and served to a user device 140 in response to a viewing instance. A viewing instance can occur, for example, when the user device 140 is utilized to view a user account 112, e.g., when a user of the user account 112 logs into the social network 110 under the user account 112, or when a user that may or may not be a member of the social network 110 utilizes the user device 140 to view the user account 112. In this implementation, one or more entity relationships related to the user account 112 can be identified, and content items 132 related to the resulting identified entity topics can be identified and served to the user device 140.

A viewing instance can also occur, for example, when the user device 140 is utilized to view a non-user account entity, such as viewing a base group 119 in a presentation environment of a web browser. In this implementation, the user device 140 may or may not be associated with a particular user account. If the user device 140 is not associated with a user account, one or more entity relationships related to the base group 119 being viewed can be identified, and content items 132 related to the resulting identified entity topics can be identified and served to the user device 140. If the user device 140 is, however, associated with a user account, one or more entity relationships related to the base group 119 being viewed and/or related to the user account 112 can be identified, and content items 132 related to the resulting identified entity topics can be identified and served to the user device 140.

In summary, by identifying entity relationships, the social network association processor 160 can identify topics that are determined to be relevant to the entity defined by the relationship. As users tend to congregate either implicitly or explicitly to such entities, content items 132, such as advertisements, can be identified and served to user devices 140 upon which a viewing instance of the entity has been instantiated.

In addition to the entity identification techniques already disclosed, other entity identification techniques can also be implemented, and the entity identification techniques can be implemented in other network settings apart from a social network. For example, entity relationships and entities can be identified by processing web logs, e.g., blogs, processing web-based communities, e.g., homeowners associations, fan sites, etc., by processing company intranets, and by processing other data sources.

In another implementation, the social network association processor 160 can, for example, identify content items 132 that should not be selected for serving to user devices 140 upon which a viewing instance of the entity has been instantiated. For example, an entity based on groups 119 related to children's television programming may define a broad entity topic related to movies. The social network association processor 160 can, however, be configured to preclude the serving of content items 132 related to R-rated movies to user devices 140 upon which a viewing instance of the entity has been instantiated.

In another implementation, the social network association processor 160 can, for example, identify acquaintances 117 and groups 119 and suggest the identified acquaintances 117 and groups 119 for inclusion into the user acquaintance data 116 and user group data 118 of a particular user account 112. For example, the social network association processor 160 may determine that a particular user associated with a user account 112 may have common interests related to the entity topics for one or more identified entities. Accordingly, the social network association processor 160 can suggest acquaintances 117 and groups 119 to the user based on the common interests related to the entity topics for the one or more identified entities.

In another implementation, the social network association processor 160 can, for example, monitor the performance of particular content items 132 that are served to user devices 140 upon which a viewing instance of the entity has been instantiated. Based on the performance, the serving of the particular content items 132 may be increased or decreased.

Likewise, the identified entity topics may be modified based on the performance of the content items 132. In one implementation, if the content items 132 related to a particular entity topic perform poorly, then the particular entity topic may be disassociated with the identified entity. For example, if an identified entity topic for an identified entity defined by a relationship is “Golf,” content items 132 related to golf, e.g., golfing advertisements, may be served to user devices 140 upon which a viewing instance of the entity has been instantiated. However, if the click through rates of the golf-related content items 132 is poor, then the identified entity topic of “Golf” may be disassociated with the identified entity.

The social network association processor 160 can, for example, be configured to identify the entity relationships, entity content, and topics on a periodic basis, e.g., weekly, monthly, etc. Other processing triggers, e.g., changes in the user account 112 corpus, group memberships, etc, can also be used.

In one implementation, the social network association processor 160 can identify related entities and aggregate content for every entity in an offline batch process. The processing results can, for example, be stored and accessed during the serving of web pages from the social network system 110 and/or from the content serving system 130. In another implementation, the social network association processor 160 can identify related entities and aggregate content for the entities in an online process, e.g., in response to a user device 140 submitting a content request to the social network system 110.

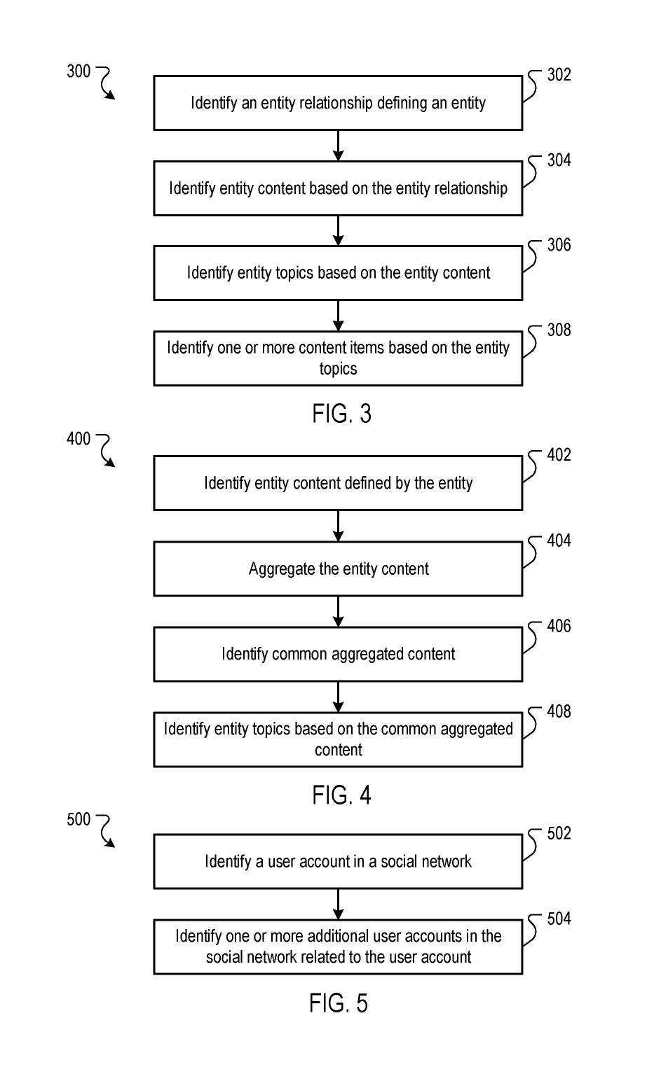

FIG. 3 is a flow diagram of an example process 300 for identifying content items and topics based an entity relationship. The process 300 can, for example, be implemented in the social network association processor 160. In one implementation, the social network association processor 160 can be integrated into the social network system 110. In another implementation, the social network association processor 160 can be integrated into the content server system 130. In another implementation, the social network association processor 160 can be a separate system in data communication with the social network system 110 and/or the content server system 130.

Stage 302 identifies an entity relationship defining an entity. For example, the social network association processor 160 can identify an entity relationship defining an entity by processing data related to user accounts 112, acquaintances 117, and user groups 119.

Stage 304 identifies entity content based on the entity relationship. For example, the social network association processor 160 can identify entity content based on the identified entity relationship by processing data related to user accounts 112 and/or groups 119.

Stage 306 identifies entity topics based on the entity content. For example, the social network association processor 160 can aggregate the entity content to identify common aggregated content.

Stage 308 identifies one or more content items based on the entity topics. For example, the social network association processor 160 can identify entity topics based on keyword and/or phrase identification, or by selecting words that are defined by a predetermined set of indexed words, etc.

Other processes for identifying content items and topics based on an entity relationship can also be used.

FIG. 4 is a flow diagram of an example process 400 for identifying entity content based on an entity relationship. The process 400 can, for example, be implemented in the social network association processor 160. In one implementation, the social network association processor 160 can be integrated into the social network system 110. In another implementation, the social network association processor 160 can be integrated into the content server system 130. In another implementation, the social network association processor 160 can be a separate system in data communication with the social network system 110 and/or the content server system 130.

Stage 402 identifies entity content defined by the entity. For example, the social network association processor 160 can identify entity content defined by the entity based on the data related to user accounts 112, acquaintances 117 and/or groups 119.

Stage 404 aggregates the entity content. For example, the social network association processor 160 can generate frequency measures for particular words or objects of the entity content.

Stage 406 identifies common aggregated content. For example, the social network association processor 160 can select particular words or objects having a frequency measure above a threshold as the common aggregated content.

Stage 408 identifies entity topics based on the common aggregated content. For example, the social network association processor 160 can identify the common aggregated content as the entity topics, or can identify keywords based on the common aggregated content.

Other processes for identifying entity content based on an entity relationship can also be used.

FIG. 5 is a flow diagram of an example process 500 for identifying an entity relationship defining an entity. The process 500 can, for example, be implemented in the social network association processor 160. In one implementation, the social network association processor 160 can be integrated into the social network system 110. In another implementation, the social network association processor 160 can be integrated into the content server system 130. In another implementation, the social network association processor 160 can be a separate system in data communication with the social network system 110 and/or the content server system 130.

Stage 502 identifies a user account in a social network. For example, the social network association processor 160 can identify user accounts 112 in the social network system 110.

Stage 504 identifies one or more additional user accounts in the social network related to the user account. For example, the social network association processor 160 can identify the one or more additional user accounts by processing the user acquaintance data 116 of the user account, or by processing the user group data 118 of the user account 112.

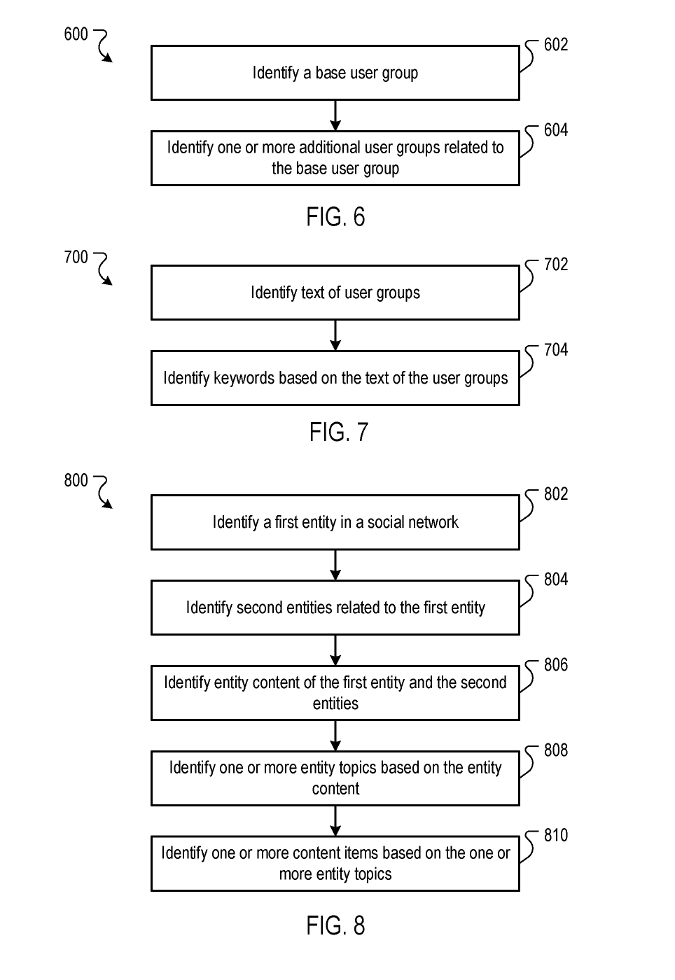

Other processes for identifying an entity relationship defining an entity can also be used. For example, FIG. 6 is a flow diagram of another example process 600 for identifying an entity relationship defining an entity. The process 600 can, for example, be implemented in the social network association processor 160. In one implementation, the social network association processor 160 can be integrated into the social network system 110. In another implementation, the social network association processor 160 can be integrated into the content server system 130. In another implementation, the social network association processor 160 can be a separate system in data communication with the social network system 110 and/or the content server system 130.

Stage 602 identifies a base user group. For example, the social network association processor 160 can identify a user group 119 for which a viewing instance has been instantiated as a base group, or can select a user group 119 as a base group.

Stage 604 identifies one or more additional user groups related to the base user group. For example, the social network association processor 160 can utilize a collaborative filter to identify related user groups; or can identify related user groups having substantially overlapping memberships; or can identify related groups based on a relevance measure of respective group content, e.g., user-submitted text; etc.

FIG. 7 is a flow diagram of an example process 700 for identifying entity topics. The process 700 can, for example, be implemented in the social network association processor 160. In one implementation, the social network association processor 160 can be integrated into the social network system 110. In another implementation, the social network association processor 160 can be integrated into the content server system 130. In another implementation, the social network association processor 160 can be a separate system in data communication with the social network system 110 and/or the content server system 130.

Stage 702 identifies text of user groups. For example, the social network association processor 160 can identity topic threads in a user group 119; or can identify user-submitted text in a user group 119, etc.

Stage 704 identifies keywords based on the text of the user groups. For example, the social network association processor 160 can identify keywords based on frequency of occurrence, or can identify keywords that are defined by a predetermined set of indexed words, etc.

In one implementation, the identified keywords can define the entity topics. In another implementation, the identified keywords can be utilized to define entity topics. For example, a set of keywords related to golf (e.g., “cleek,” “dimples,” “divot,” “hosel,” etc.) can be utilized to define the broad topic “golf.”

Other processes for identifying entity topics can also be used.

FIG. 8 is a flow diagram of an example process 800 for identifying content items based on a relationship defined by entities in a social network. The process 800 can, for example, be implemented in the social network association processor 160. In one implementation, the social network association processor 160 can be integrated into the social network system 110. In another implementation, the social network association processor 160 can be integrated into the content server system 130. In another implementation, the social network association processor 160 can be a separate system in data communication with the social network system 110 and/or the content server system 130.

Stage 802 identifies a first entity in a social network. For example, the social network association processor 160 can identify a user account 112, or a group 119.

Stage 804 identifies second entities related to the first entity. In one implementation, the social network association processor 160 can identify other user accounts 112 related to the identified user account 112 by comparing some or all of the user account 112 data to the data of other user accounts 112, e.g., user profile data 114, user acquaintance data 116, user options 122, etc.

In another implementation, the social network association processor 160 can identify other groups 119 related to the identified group 119 by utilizing a collaborative filter, or by comparing group memberships, or by comparing respective group content.

Stage 806 identifies entity content of the first entity and the second entities. For example, the social network association processor 160 can identify user profile data 114, or other user account data, of user accounts 112 defined by the identified entity; or can identify text and/or objects of groups 119 defined by the identified entity, etc.

Stage 808 identifies one or more entity topics based on the entity content. For example, the social network association processor 160 can aggregate the entity content to identify common aggregated content and define the common aggregated content as entity topics; or can perform keyword processing on the identified content to identity keywords, etc.

Stage 810 identifies one or more content items based on the one or more entity topics. For example, the social network association processor 160 and/or the content serving system 130 can identify content items 132, e.g., advertisements, based on a relevance measure of the content items 132 to the identified entity topics.

FIG. 9 is block diagram of an example computer system 900. The system 900 includes a processor 910, a memory 920, a storage device 930, and an input/output device 940. Each of the components 910, 920, 930, and 940 can, for example, be interconnected using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930.

The memory 920 stores information within the system 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the system 900. In one implementation, the storage device 930 is a computer-readable medium. In various different implementations, the storage device 930 can, for example, include a hard disk device, an optical disk device, or some other large capacity storage device.

The input/output device 940 provides input/output operations for the system 900. In one implementation, the input/output device 940 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 960.

The apparatus, methods, flow diagrams, and structure block diagrams described in this patent document may be implemented in computer processing systems including program code comprising program instructions that are executable by the computer processing system. Other implementations may also be used. Additionally, the flow diagrams and structure block diagrams described in this patent document, which describe particular methods and/or corresponding acts in support of steps and corresponding functions in support of disclosed structural means, may also be utilized to implement corresponding software structures and algorithms, and equivalents thereof.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A system for reducing data noise using frequency analysis, the system comprising:
a data storage device that stores content; and
a network association processor in data communication with the data storage device and that performs operations comprising:
aggregating, for a given group, content of one or more additional groups that each have overlapping members with the given group, wherein each of the one or more additional groups has an associated topic that is different from a topic of the given group;
reducing noise in the aggregated content of the one or more additional groups using frequency analysis, including:
determining, for each portion of content in the aggregated content, a frequency of occurrence of the portion of content within the aggregated content; and
filtering, from the aggregated content, each portion of content that has a frequency of occurrence that is less than a threshold;
identifying, as group topics for the given group, phrases included in the aggregated content that remains in the aggregated content after reducing the noise;
selecting, from the content stored in the data storage device, one or more portions of content using the identified group topics of the one or more additional groups; and
providing the one or more portions of content for display at a device of a member of the given group during a viewing instance of the given group at the device, wherein the member of the given group is not a member of the one or more additional groups.

2. The system of claim 1, wherein reducing the noise in the aggregated content further comprises determining that a given portion of content that is related to a given topic for which content is found in only one of the one or more additional groups and, in response, filtering the given portion of content from the aggregated content.

3. The system of claim 1, wherein identifying, as the group topics for the given group, phrases included in the aggregated content that remains in the aggregated content after reducing the noise comprises identifying one or more phrases having a highest frequency of occurrence within the aggregated content as the group topics for the given group.

4. The system of claim 1, wherein the network association processor performs further operations comprising:
identifying a user interaction rate for content related to a given topic of the group topics when the content is presented to members of the given group; and
removing the given topic from the group topics for the given group based on the identified performance.

5. The system of claim 1, wherein aggregating, for a given group, content of one or more additional groups that each have overlapping members with the given group comprises:
identifying a particular group as being related to the given group based on a relevance measure for content of the particular group and content of the given group;
including content of the particular group in the aggregated content.

6. The system of claim 1, wherein providing the one or more portions of content for display at a device of a member of the given group during a viewing instance of the given group at the device comprises:
identifying an entity relationship between the member of the given group and an additional user;
identifying one or more additional portions of content based on the entity relationship; and
providing the one or more additional portions of content for display at the device of the member of the given group.

7. The system of claim 1, wherein the network association processor aggregates the content of the one or more additional groups and reduces the noise in the aggregated content of the one or more additional groups using an offline batch process.

8. A computer-implemented method, comprising:
aggregating, for a given group, content of one or more additional groups that each have overlapping members with the given group, wherein each of the one or more additional groups has an associated topic that is different from a topic of the given group;
reducing noise in the aggregated content of the one or more additional groups using frequency analysis, including:
determining, for each portion of content in the aggregated content, a frequency of occurrence of the portion of content within the aggregated content; and
filtering, from the aggregated content, each portion of content that has a frequency of occurrence that is less than a threshold;
identifying, as group topics for the given group, phrases included in the aggregated content that remains in the aggregated content after reducing the noise;
selecting, from content stored in a data storage device, one or more portions of content using the identified group topics of the one or more additional groups; and
providing the one or more portions of content for display at a device of a member of the given group during a viewing instance of the given group at the device, wherein the member of the given group is not a member of the one or more additional groups.

9. The method of claim 8, wherein reducing the noise in the aggregated content further comprises determining that a given portion of content that is related to a given topic for which content is found in only one of the one or more additional groups and, in response, filtering the given portion of content from the aggregated content.

10. The method of claim 8, wherein identifying, as the group topics for the given group, phrases included in the aggregated content that remains in the aggregated content after reducing the noise comprises identifying one or more phrases having a highest frequency of occurrence within the aggregated content as the group topics for the given group.

11. The method of claim 8, further comprising:
identifying a user interaction rate for content related to a given topic of the group topics when the content is presented to members of the given group; and
removing the given topic from the group topics for the given group based on the identified performance.

12. The method of claim 8, wherein aggregating, for a given group, content of one or more additional groups that each have overlapping members with the given group comprises:
identifying a particular group as being related to the given group based on a relevance measure for content of the particular group and content of the given group;
including content of the particular group in the aggregated content.

13. The method of claim 8, wherein providing the one or more portions of content for display at a device of a member of the given group during a viewing instance of the given group at the device comprises:
identifying an entity relationship between the member of the given group and an additional user;
identifying one or more additional portions of content based on the entity relationship; and
providing the one or more additional portions of content for display at the device of the member of the given group.

14. The method of claim 8, wherein an offline batch process is used to aggregate the content of the one or more additional groups and reduce the noise in the aggregated content of the one or more additional groups.

15. A non-transitory computer storage medium encoded with a computer program, the program comprising instructions that when executed by one or more data processing apparatus cause the data processing apparatus to perform operations comprising:
aggregating, for a given group, content of one or more additional groups that each have overlapping members with the given group, wherein each of the one or more additional groups has an associated topic that is different from a topic of the given group;
reducing noise in the aggregated content of the one or more additional groups using frequency analysis, including:
determining, for each portion of content in the aggregated content, a frequency of occurrence of the portion of content within the aggregated content; and
filtering, from the aggregated content, each portion of content that has a frequency of occurrence that is less than a threshold;
identifying, as group topics for the given group, phrases included in the aggregated content that remains in the aggregated content after reducing the noise;
selecting, from content stored in a data storage device, one or more portions of content using the identified group topics of the one or more additional groups; and
providing the one or more portions of content for display at a device of a member of the given group during a viewing instance of the given group at the device, wherein the member of the given group is not a member of the one or more additional groups.

16. The non-transitory computer storage medium of claim 15, wherein reducing the noise in the aggregated content further comprises determining that a given portion of content that is related to a given topic for which content is found in only one of the one or more additional groups and, in response, filtering the given portion of content from the aggregated content.

17. The non-transitory computer storage medium of claim 15, wherein identifying, as the group topics for the given group, phrases included in the aggregated content that remains in the aggregated content after reducing the noise comprises identifying one or more phrases having a highest frequency of occurrence within the aggregated content as the group topics for the given group.

18. The non-transitory computer storage medium of claim 15, wherein the operations further comprise:
identifying a user interaction rate for content related to a given topic of the group topics when the content is presented to members of the given group; and
removing the given topic from the group topics for the given group based on the identified performance.

19. The non-transitory computer storage medium of claim 15, wherein aggregating, for a given group, content of one or more additional groups that each have overlapping members with the given group comprises:
identifying a particular group as being related to the given group based on a relevance measure for content of the particular group and content of the given group;
including content of the particular group in the aggregated content.

20. The non-transitory computer storage medium of claim 15, wherein providing the one or more portions of content for display at a device of a member of the given group during a viewing instance of the given group at the device comprises:
identifying an entity relationship between the member of the given group and an additional user;
identifying one or more additional portions of content based on the entity relationship; and
providing the one or more additional portions of content for display at the device of the member of the given group.
